(19) United States
(12) Patent Application Publication
(10) Pub. No.: US 2022/0171916 A1
(43) Pub. Date: Jun. 2, 2022

(54) APPARATUS, SYSTEM, AND METHOD FOR MERGING SECTIONS OF DOCUMENTS

(71) Applicant: Rowan TELS Corp., Seattle, WA (US)

(72) Inventors: Benjamin Demboski, Seattle, WA (US); Chad Kirby, Seattle, WA (US); David Billmaier, Woodinville, WA (US)

(73) Assignee: Rowan TELS Corp., Seattle, WA (US)

(21) Appl. No.: 17/110,090

(22) Filed: Dec. 2, 2020

(51) Int. Cl. G06F 40/106; G06F 40/169; G06F 16/93; G06F 40/143; G06F 3/0483

(52) U.S. Cl. CPC G06F 40/106; G06F 40/169; G06F 3/0483; G06F 40/143; G06F 16/93

(57) ABSTRACT

A method, system and apparatus for merging sections of documents is disclosed. A selected section of a source document is parsed for cross-references with a selected section of the document identified for merging into a target document. With the cross-reference found within the selected section, a cross-referenced section is determined within the source document. The identification of a cross-reference to the cross-referenced section within the selected section may be reported to a user. This identification may additionally serve as a basis for resolving an unresolved cross-reference. Finally, the selected section may merge into the target document with resolution of unresolved cross-references.

### BACKGROUND

Creating a set of linked references between document sections has a long publishing history and appears relatively straightforward—until the task of merging new material with its own references arises. Newly introduced references necessitate resolution, most particularly when they refer to section(s) of an original document not present in the one to which they have been moved.

Documents of various kinds have different sections: books divide into chapters, patent documents comprise a proscribed order and number of sections, and some technical documents even rely on strict section standards such as those published by the International Organization for Standardization (ISO). Regardless of the document type, however, printed content in sections may be linked by specific elements (e.g., objects) designed for this purpose. Since they provide links to other document sections, these elements represent more than the text, e.g., word or phrase, as it appears in a display medium. A link on a standard web page illustrates a simple example: a user may click on it as well as read it. In whatever form a link or reference may take, content in some sections of documents refers to other sections.

When drafting a document with sections, a writer often wants to assemble an updated document from an existing collection of sections. Maintaining consistent cross-references within existing document sections presents a challenge, particularly when fewer than all the sections of a source document merge into a target document. When linked objects merge into a target document without accompanying cross-referenced section(s), the links refer to a section that doesn't exist. They become what is commonly known as “broken links.” Since cross-references hold little value without their associated references, the same technologies enabling a flexible arrangement of document sections may overcome this obstacle by maintaining a consistency between merged sections of a target document. A patent document provides a good example of a document requiring such consistency. FIG. 1 by definition precedes FIG. 2. Part numbers receive a “100” level number based on the patent drawing section where they are introduced—and generally keep that number unless an alternative embodiment is being described. Merging a new figure between FIGS. 1 and 2 may simply renumber every figure from FIG. 2 onward, but merging other cross-references may present more resolution complexity.

Thus, there is a need for effective resolution of merged cross-references in multi-section documents.

### BRIEF SUMMARY

An apparatus, system, and method for merging sections of documents is disclosed. In one embodiment, a method for merging of documents is disclosed, comprising parsing a selected section of a source document for at least one cross-reference. The selected section is then identified for merger into a target document, determining a cross-referenced section within the source document in response to identifying at least one cross-reference within the selected section, reporting that the selected section includes a cross-reference to the cross-referenced section, and merging the selected section into the target document.

In another embodiment, a system is disclosed comprising a user interface configured to present a source patent document and a target patent document to a user and receive an indication of a patent drawing section of the source patent document for merger into the target patent document, from a user, a consistency module configured to identify a cross-reference within the indicated patent drawing section, the cross-reference referencing another patent drawing section of the source patent document, and a resolution module configured to merge the indicated patent drawing section and the another patent drawing section into the target patent document and maintain consistency between cross-references within the target patent document.

In still another embodiment, a computing apparatus is disclosed, comprising a processor and a memory storing instructions that, when executed by the processor, configure the apparatus to determine a first patent drawing section identified for merger into a target patent document, determining that the first patent drawing section comprises a first cross-reference to a second patent drawing section, determining that the second patent drawing section comprises the first cross-reference to a third patent drawing section, and appending the first patent drawing section, the second patent drawing section, and the third patent drawing section onto the target patent document.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an example block diagram of a computing device 100 that may incorporate certain embodiments of this solution.

FIG. 2 illustrates a client server network configuration 200 in accordance with one embodiment.

FIG. 3 illustrates a document structure 300 in accordance with one embodiment.

FIG. 4 illustrates a two patent documents 400 in accordance with one embodiment.

FIG. 5 illustrates a user interface and modules 500 in accordance with one embodiment.

FIG. 6 illustrates a user interface and module detail 600 in accordance with one embodiment.

FIG. 7 illustrates a merge attributes 700 in accordance with one embodiment.

FIG. 8 illustrates a source patent document 800 in accordance with one embodiment.

FIG. 9 illustrates a source patent document 900 in accordance with one embodiment.

FIG. 10 illustrates a source patent document 1000 in accordance with one embodiment.

FIG. 11 illustrates a figure sections 1100 in accordance with one embodiment.

FIG. 12 illustrates a target patent document 1200 in accordance with one embodiment.

FIG. 13 illustrates a routine 1300 in accordance with one embodiment.

### DETAILED DESCRIPTION

When importing, merging in, or combining one portion of a source document into a target document, a user may not notice links in the desired section within the source document to content in other sections of the source document. “Source document” refers to a document that serves as a source for a set of symbols, material, content, or text to be used for a particular purpose. “Target document” refers to a document that serves as a target, or destination, for a set of symbols, material, content, or text to be used for a particular purpose. In one embodiment, the target document is a document that is intended to receive content such as text, a section that includes text, a patent drawing section, or the like.

A technical problem arises because importing a particular section may result in broken links (i.e., cross-references) because the linked section is not included or designated for the import. Resolution of the broken links may be needed to fully import the desired section of the source document. A solution for effective resolution of merged cross-references in multi-section documents may generally include detecting a lack of resolution, e.g., a “broken link,” and then resolving it by either prompting a user to interactively attend it or converting the broken link into non-linking content.

An apparatus, system, and method for merging sections of documents is disclosed. A technical difficulty arising from merging documents comprises unresolved (or “broken”) cross-references. This difficulty frequently accompanies documents with sections, as the latter are often rearranged and/or collected by a user to create a new document. The current disclosure addresses this challenge by first detecting the unresolved cross-references. The cross-references and their associated cross-referenced sections may then be reported, e.g., highlighted in a document via the aid of computer instructions. Reporting may be automatic, e.g, without user input, or manual. In the latter case, a user may be interactively queried via a user interface as to how he wants to resolve the reported broken link(s).

A second technical problem addressed by the current disclosure comprises avoiding unresolved cross-references proactively. A user may merge a document section via a drag-and-drop user interface, e.g., from a source document to a target document. The challenge arises from protecting the target document from the unresolved cross-references. By detecting the cross-reference to an object outside a section at the time of the document merger, the current disclosure avoids the difficulty of after-the-fact resolution. An unresolved cross-reference in this case is either resolved automatically or with user assistance.

Another disclosed technical solution of resolving cross-references includes tracing three or more of them through their corresponding document sections. In one instance, the cross-referenced sections may append to the end of the target document. An exemplary document type for all these embodiments includes a patent document, with proscribed sections such as background, summary, detailed description, conclusion, claims, and so on.

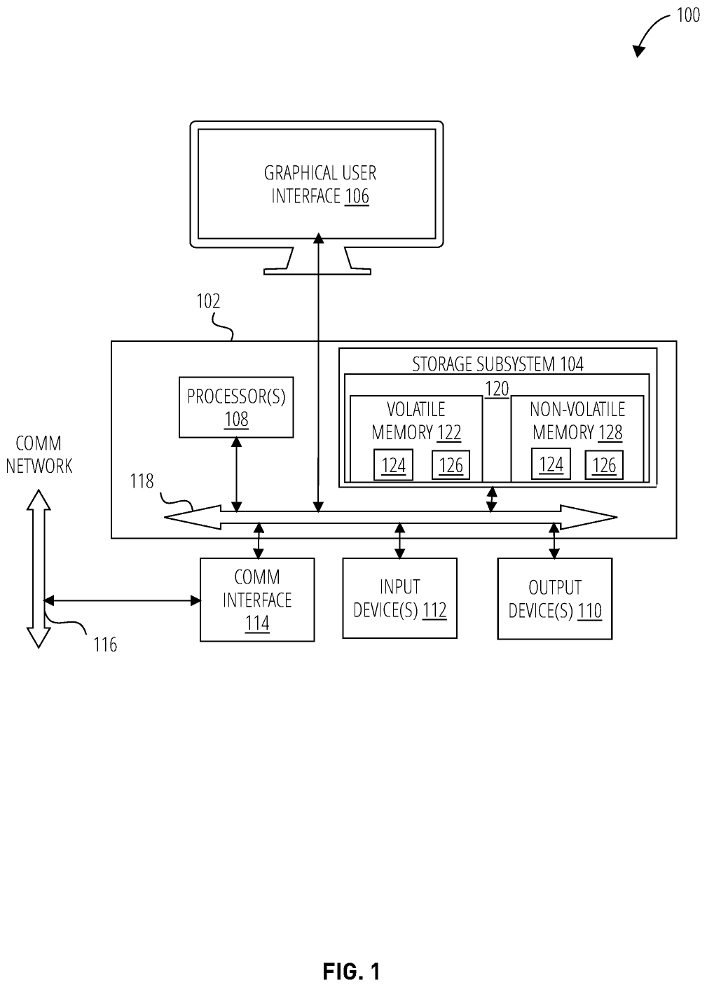

FIG. 1 is an example block diagram of a computing device 100 that may incorporate embodiments of the claimed solution. FIG. 1 is merely illustrative of a machine system to carry out aspects of the technical processes described herein and does not limit the scope of the claims. One of ordinary skill in the art would recognize other variations, modifications, and alternatives. In certain embodiments, the computing device 100 includes a graphical user interface 106, a data processing system 102, a communication network 116, communication network interface 114, input device(s) 112, output device(s) 110, and the like.

As depicted in FIG. 1, the data processing system 102 may include one or more processor(s) 108 and a storage subsystem 104. The processor(s) 108 communicate with a number of peripheral devices via a bus subsystem 118. These peripheral devices may include input device(s) 112, output device(s) 110, communication network interface 114, and the storage subsystem 104. The storage subsystem 104, in one embodiment, comprises one or more storage devices and/or one or more memory 120 devices.

“Processor” refers to any circuitry, component, chip, die, package, or module configured to receive, interpret, decode, and execute machine instructions. Examples of a processor may include, but are not limited to, a central processing unit, a general-purpose processor, an application-specific processor, a graphics processing unit (GPU), a field programmable gate array (FPGA), Application Specific Integrated Circuit (ASIC), System on a Chip (SoC), virtual processor, processor core, and the like.

“Storage device” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like.

“Memory” refers to any hardware, circuit, component, module, logic, device, or apparatus configured, programmed, designed, arranged, or engineered to retain data. Certain types of memory need availability of a constant power source to store and retain the data. Other types of memory retain and/or store the data when a power source is unavailable.

In one embodiment, the storage subsystem 104 includes a volatile memory 122 and a non-volatile memory 128. The volatile memory 122 and/or the non-volatile memory 128 may store computer-executable instructions 126 that alone or together form logic 124 that when applied to, and executed by, the processor(s) 108 implement embodiments of the processes disclosed herein.

“Volatile memory media” refers to any hardware, device, component, element, or circuit configured to maintain an alterable physical characteristic used to represent a binary value of zero or one for which the alterable physical characteristic reverts to a default state that no longer represents the binary value when a primary power source is removed or unless a primary power source is used to refresh the represented binary value. Examples of volatile memory media include but are not limited to dynamic random-access memory (DRAM), static random-access memory (SRAM), double data rate random-access memory (DDR RAM) or other random access solid state memory While the volatile memory media is referred to herein as “memory media,” in various embodiments, the volatile memory media may more generally be referred to as volatile memory. In certain embodiments, data stored in volatile memory media is addressable at a byte level which means that the data in the volatile memory media is organized in to bytes (8 bits) of data that each have a unique address, such as a logical address. “Volatile memory” refers to a shorthand name for volatile memory media. In certain embodiments, volatile memory refers to the volatile memory media and the logic, controllers, processor(s), state machine(s), and/or other periphery circuits that manage the volatile memory media and provide access to the volatile memory media.

“Non-volatile memory media” refers to any hardware, device, component, element, or circuit configured to maintain an alterable physical characteristic used to represent a binary value of zero or one after a primary power source is removed. “Non-volatile memory” refers to shorthand name for non-volatile memory media. In certain embodiments, non-volatile memory media refers to the non-volatile memory media and the logic, controllers, processor(s), state machine(s), and/or other periphery circuits that manage the non-volatile memory media and provide access to the non-volatile memory media.

“Logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The input device(s) 112 include devices and mechanisms for inputting information to the data processing system 102. These may include a keyboard, a keypad, a touch screen incorporated into the graphical user interface 106, audio input devices such as voice recognition systems, microphones, and other types of input devices. In various embodiments, the input device(s) 112 may be embodied as a computer mouse, a trackball, a track pad, a joystick, wireless remote, drawing tablet, voice command system, eye tracking system, and the like. The input device(s) 112 typically allow a user to select objects, icons, control areas, text and the like that appear on the graphical user interface 106 via a command such as a click of a button or the like.

The output device(s) 110 include devices and mechanisms for outputting information from the data processing system 102. These may include the graphical user interface 106, speakers, printers, infrared LEDs, and so on, as well understood in the art. In certain embodiments, the graphical user interface 106 is coupled to the bus subsystem 118 directly by way of a wired connection. In other embodiments, the graphical user interface 106 couples to the data processing system 102 by way of the communication network interface 114. For example, the graphical user interface 106 may comprise a command line interface on a separate computing device 100 such as desktop, server, or mobile device.

The communication network interface 114 provides an interface to communication networks (e.g., communication network 116) and devices external to the data processing system 102. The communication network interface 114 may serve as an interface for receiving data from and transmitting data to other systems. Embodiments of the communication network interface 114 may include an Ethernet interface, a modem (telephone, satellite, cable, ISDN), (asynchronous) digital subscriber line (DSL), FireWire, USB, a wireless communication interface such as Bluetooth or WiFi, a near field communication wireless interface, a cellular interface, and the like.

The communication network interface 114 may be coupled to the communication network 116 via an antenna, a cable, or the like. In some embodiments, the communication network interface 114 may be physically integrated on a circuit board of the data processing system 102, or in some cases may be implemented in software or firmware, such as “soft modems”, or the like.

The computing device 100 may include logic that enables communications over a network using protocols such as HTTP, TCP/IP, RTP/RTSP, IPX, UDP and the like.

The volatile memory 122 and the non-volatile memory 128 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 122 and the non-volatile memory 128 may be configured to store the basic programming and data constructs that provide the functionality of the disclosed processes and other embodiments thereof that fall within the scope of the present disclosure.

Logic 124 that implements one or more parts of embodiments of the solution may be stored in the volatile memory 122 and/or the non-volatile memory 128. Logic 124 may be read from the volatile memory 122 and/or non-volatile memory 128 and executed by the processor(s) 108. The volatile memory 122 and the non-volatile memory 128 may also provide a repository for storing data used by the logic 124.

The volatile memory 122 and the non-volatile memory 128 may include a number of memories including a main random access memory (RAM) for storage of instructions and data during program execution and a read only memory (ROM) in which read-only non-transitory instructions are stored. The volatile memory 122 and the non-volatile memory 128 may include a file storage subsystem providing persistent (non-volatile) storage for program and data files. The volatile memory 122 and the non-volatile memory 128 may include removable storage systems, such as removable flash memory.

The bus subsystem 118 provides a mechanism for enabling the various components and subsystems of data processing system 102 communicate with each other as intended. Although the communication network interface 114 is depicted schematically as a single bus, some embodiments of the bus subsystem 118 may utilize multiple distinct busses.

It will be readily apparent to one of ordinary skill in the art that the computing device 100 may be a device such as a smartphone, a desktop computer, a laptop computer, a rack-mounted computer system, a computer server, or a tablet computer device. As commonly known in the art, the computing device 100 may be implemented as a collection of multiple networked computing devices. Further, the computing device 100 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

The apparatuses, systems, and/or methods disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However, the system need not necessarily be accessed over a network and could, in some embodiments, be implemented by one or more app or applications on a single device or distributed between a mobile device and a computer, for example.

“Instructions” refers to symbols representing commands for execution by a device using a processor, microprocessor, controller, interpreter, or other programmable logic. Broadly, ‘instructions’ may mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Programmable device” refers to any logic (including hardware and software logic) who's operational behavior is configurable with instructions.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“App” refers to a type of application, most commonly associated with applications executed on mobile devices. Apps tend to have a more limited feature set and simpler user interface than applications as those terms are commonly understood in the art.

“Driver” refers to low-level logic, typically software, that controls components of a device. Drivers often control the interface between an operating system or application and input/output components or peripherals of a device, for example.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Subsection” refers to a set of words, phrases, and/or symbols organized into part of a section. A subsection organizes the words, phrases, and/or symbols to convey one or more topics. Example of a subsection include a paragraph, clause, or the like.

“Task” refers to one or more operations that a process performs.

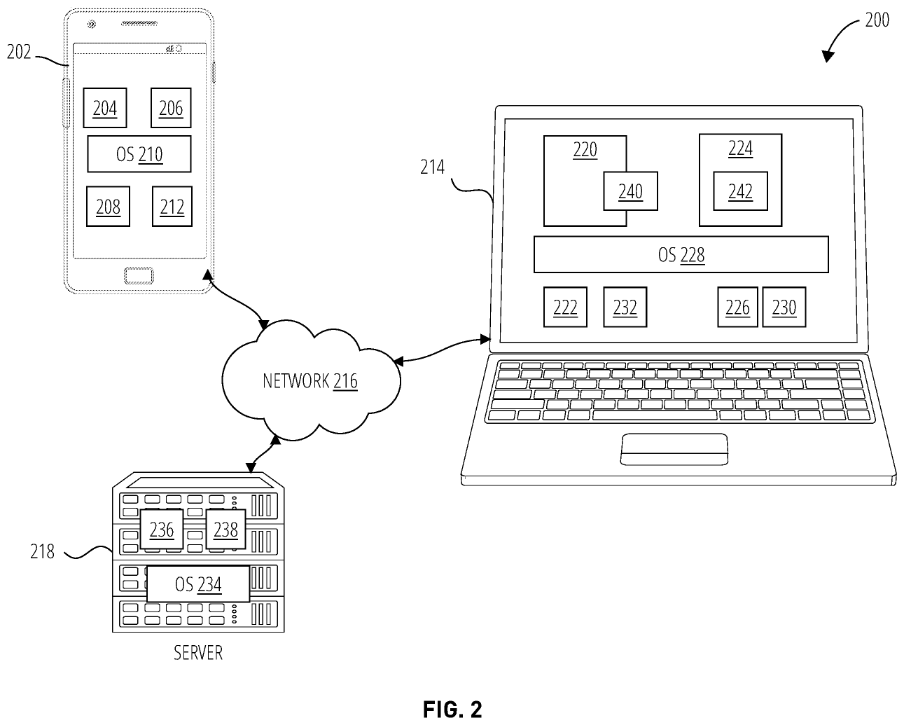

Referring to FIG. 2, a client server network configuration 200 illustrates various computer hardware devices and software modules coupled by a network 216 in one embodiment. Each device includes a native operating system, typically pre-installed on its non-volatile RAM, and a variety of software applications or apps for performing various functions.

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is needed in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

The mobile programmable device 202 comprises a native operating system 210 and various apps (e.g., app 204 and app 206). A computer 214 also includes an operating system 228 that may include one or more libraries of native routines to run executable software on that device. The computer 214 also includes various executable applications (e.g., application 220 and application 224). The mobile programmable device 202 and computer 214 are configured as clients on the network 216. A server 218 is also provided and includes an operating system 234 with native routines specific to providing a service (e.g., service 238 and service 236) available to the networked clients in this configuration.

“Executable” refers to a file comprising executable code. If the executable code is not interpreted computer code, a loader is typically used to load the executable for execution by a programmable device.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

“Computer code” refers to any of source code, object code, or executable code.

“Computer program” refers to another term for ‘application’ or ‘app’.

“Computer code section” refers to one or more instructions.

“Instructions” refers to symbols representing commands for execution by a device using a processor, microprocessor, controller, interpreter, or other programmable logic. Broadly, ‘instructions’ may mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Source code” refers to a high-level textual computer language that needs either interpretation or compilation in order to be executed by a device.

“Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported.

“Object code” refers to the computer code output by a compiler or as an intermediate output of an interpreter. Object code often takes the form of machine language or an intermediate language such as register transfer language (RTL).

“Executable code” refers to instructions in a ready-to-execute form by a programmable device. For example, source code instructions in non-interpreted execution environments are not executable code because they usually first undergo compilation, linking, and loading by the operating system before they have the proper form for execution. Interpreted computer code may be considered executable code because it may be directly applied to a programmable device (an interpreter) for execution, even though the interpreter itself may further transform the interpreted computer code into machine language instructions.

“Machine language” refers to instructions in a form that is directly executable by a programmable device without further translation by a compiler, interpreter, or assembler. In digital devices, machine language instructions are typically sequences of ones and zeros.

“Algorithm” refers to a set of instructions configured to cause a machine to carry out a particular function or process.

“Application program interface” refers to instructions implementing entry points and return values to a module.

A compiler is typically used to transform source code into object code and thereafter a linker combines object code files into an executable application, recognized by those skilled in the art as an “executable”. The distinct file comprising the executable would then be available for use by the computer 214, mobile programmable device 202, and/or server 218. Any of these devices may employ a loader to place the executable and any associated library in memory for execution. The operating system executes the program by passing control to the loaded program code, creating a task or process. An alternate means of executing an application or app involves the use of an interpreter (e.g., interpreter 242) that interprets interpreted computer code.

“Compiler” refers to logic that transforms source code from a high-level programming language into object code or in some cases, into executable code.

“Linker” refers to logic that inputs one or more object code files generated by a compiler or an assembler and combines them into a single executable, library, or other unified object code output. One implementation of a linker directs its output directly to machine memory as executable code (performing the function of a loader as well).

“Loader” refers to logic for loading programs and libraries. The loader is typically implemented by the operating system. A typical loader copies an executable into memory and prepares it for execution by performing certain transformations, such as on memory addresses.

“Library” refers to a collection of modules organized such that the functionality of all the modules may be included for use by software using references to the library in source code.

“Process” refers to software that is in the process of being executed on a device.

“Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Interpreted computer code” refers to instructions in a form suitable for execution by an interpreter.

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, driver, such as driver 208 or driver 212, on the mobile programmable device 202 or computer 214 (e.g., driver 222 and driver 232) might enable wireless headphones to be used for audio output(s) and a camera to be used for video inputs. Any of the devices may read and write data from and to files (e.g., file 226 or file 230) and applications or apps may utilize one or more plug-in (e.g., plug-in 240) to extend their capabilities (e.g., to encode or decode video files).

“Plug-in” refers to software that adds features to an existing computer program without rebuilding (e.g., changing or re-compiling) the computer program. Plug-ins are commonly used for example with Internet browser applications.

The network 216 in the client server network configuration 200 may be of a type understood by those skilled in the art, including a Local Area Network (LAN), Wide Area Network (WAN), Transmission Communication Protocol/Internet Protocol (TCP/IP) network, and so forth. These protocols used by the network 216 dictate the mechanisms by which data is exchanged between devices.

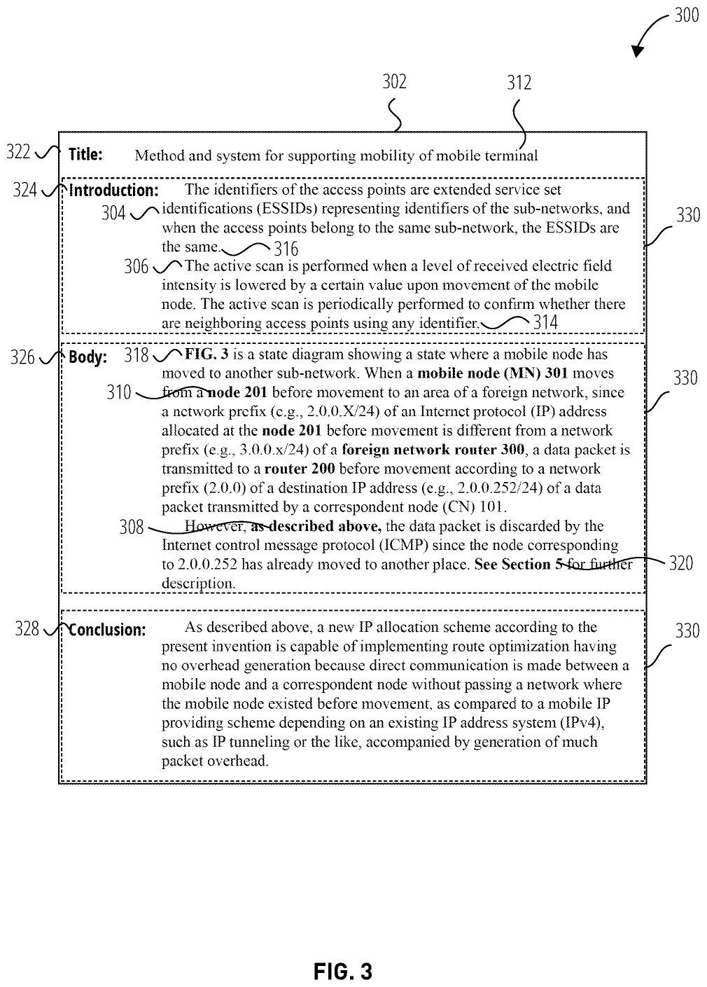

Referring to FIG. 3, a document structure 300 is illustrated. An exemplary document comprising a title 322, introduction 324, body 326 and conclusion 328 is shown, all additionally comprising text 312, arranged in a variety of forms and including specific indicators. The entirety of the text 312 includes a document 302, which may be a patent document, as schematically illustrated, or another document known to those skilled in the art. The exemplary document comprises a document order, paragraphs, sections, sentences and an ability to refer from one part of the text 312 to another part, e.g., a drawing part.

“Document” refers to a collection of words, phrases, and/or symbols organized on, or in, a medium to communicate, preserve, and/or retain information. In one embodiment, a document comprises two or more sections. In certain embodiments, a document comprises a set of ordered sections. Within the set of ordered sections, one section is presented to a reader before another section, when the reader reviews the document in a conventional document order.

“Ordered sections” refers to a set of sections organized into a predefined order. In certain embodiments, the ordering of the sections is done to promote uniformity and facilitate presentation and organization of certain information. Certain documents, such as patent documents may designated a prescribed order for the sections. As a representative example, in a patent document such as a United States patent application, the first section is the title, the second section is the cross-reference section, the third section is the background section, the fourth section is the summary section, the fifth section is the brief description of the figures section, the sixth section is the detailed description section, the seventh section is the claims section, and the abstract section is the final section. The patent document may optionally including a drawing section which may not have a predefined order relative to the other ordered sections of the patent document.

The document 302 as shown breaks down into a plurality of sections, each section 330 labeled here, e.g., introduction 324, body 326, and conclusion 328, to distinguish it from another. Text 312 within a section 330 may, in certain embodiments, be further subdivided into one or more paragraphs. An end of a paragraph 314 distinguishes paragraph 306 completion, i.e., the text 312 following the end of a paragraph 314 representing the start of another section 330 or paragraph 306 in the document 302. Each paragraph 306 comprises one or more sentences, the sentence 304 completion distinguished by an end of a sentence 316, i.e., in English grammar indicated with the symbol of a period (.). An end of a sentence 316 may be located within a paragraph 306, at the end of a paragraph 314, at the end of a section 330, or the end of an entire document 302.

“Text” refers to a collection of words, phrases, and/or symbols configured to convey information in a human readable format. In one embodiment, “text” refers to a main body of printed or written matter of a document. In another embodiment, “text” refers to portion of a main body of printed or written matter of a document.

“Section” refers to a set of words, phrases, and/or symbols organized into part of a document. In certain embodiments, a section is a mechanism for organizing the information and material presented in a document such that the information is presented in a predefined, accepted, mandated, standard, or regulated manner. For example, in a patent document, prescribed sections may be defined by regulation or law. In one embodiment, a section comprises a structural component of a document. A section may include one or more sections, which may also be referred to herein as one or more subsections. In one embodiment, certain content of a section is represented by one or more strings of text. The strings of text may be organized into sentences and/or paragraphs and may include punctuation and/or symbols and/or tags that define markup language elements in a markup language. In certain embodiments, a section comprises a clause. In another embodiment, a section comprises a drawing object and a markup language string that may include markup language elements.

“Paragraph” refers to an ordered set of sentences organized to convey one or more concepts to a reader. Often, the one or more concepts are related to each other and/or relate to one or more general topics.

“Sentence” refers to an ordered set of words, phrases, and/or symbols organized to convey one or more concepts to a reader. In one embodiment, a sentence includes punctuation positioned at the end of the set to indicate where the sentence ends.

“Markup language” refers to a type of source code, a language that annotates text so that a computing device may manipulate the text. A markup language uses tags to identify, describe, and define parts within a document. A markup language is human-readable and uses words, text and text symbols to convey the syntax and structure of the document.

“Markup language element” refers to a part of a document. In one embodiment, a markup language element identifies a part of a text document and how that part of the document is to be annotated and/or presented when displayed or processed. Markup language elements conform to a standard in which the markup language element includes a start tag and an end tag, each made up of certain symbols, such as ‘<’, ‘>’, ‘/’. text characters and symbols between the tags and attributes within the start tag and/or an end tag define the markup language element.

“Tag” refers to an identifier for a markup language element. A tag may have one of two types, a start tag or an end tag. In certain embodiments, a start tag may include attributes for a markup language element while an end tag does not include attributes. In such embodiments, references to “tag” may be interpreted as short hand references to a start tag of a markup language element.

“Markup language string” refers to a string of text that includes one or more markup language elements. Examples of a markup language string include, but are not limited to, an Hyper Text Markup Language (HTML) string, an eXtensible Markup Language (XML) string, and the like.

Within the text 312 of a section 330, paragraph 306, and/or sentence 304 of a document 302, a variety of references may be introduced to aid the reader or user in referring to other parts of interest of the same or other document 302. FIG. 3 illustrates three exemplary types of references for a patent document, each reference well known to one skilled in the art. First, a drawing reference 318 refers to a figure (e.g., FIG. 3, as shown) included in the same or other document 302 and often numbered in a predefined order. Second, a part number reference 310 of a patent document refers to a drawing part, e.g., “Node” labeled with a number e.g., “201”. A patent document figure includes the part number reference 310. The part number reference 310 allows the reader of a patent document to easily refer to a drawing part within a figure of a patent document while reading text 312 referring to the same drawing part. Finally, a document position reference 308 indicates another part of the text 312 in a document 302. The document position reference 308 typically but not exclusively indicates that the position exists either above or below the reference, e.g., “as described above” as shown. The document position reference 308 may assist the reader of a patent document or other document 302 by reminding the reader of material already discussed (e.g., “as . . . above”), material to come (e.g., “as . . . below”) or otherwise located in the text 312 of the same document 302 or other document 302. The document position reference 308 may, like the drawing reference 318 and part number reference 310, be included in a section 330, paragraph 306, and/or sentence 304 of a document 302.

“Reference” refers to any symbol, character, string, token, element, or object that directs a user or logic to another markup language element within a different section of a document. Examples of a reference include but are not limited to, a hyper link, an href, a Uniform Resource Locator (URL), a Uniform Resource Name (URN), a Uniform Resource Identifier (URI), and the like.

“Drawing reference” refers to a text string value comprising one or more words and/or symbols that refer a reader to a patent drawing of a patent document. In one embodiment, a drawing reference comprises a patent document object that links to, or refers to, a patent drawing section of a patent document. A drawing reference, in certain embodiments may include a text value used in content of a presentation of the drawing reference and/or a markup language element used by computer code to manage the markup language element. Examples of text values that a drawing reference may comprise include, but are not limited to, “Fig. N”, “Figure N”, “FIG. N”, “FIGURE N”, and the like, where “N” is a whole number for a numbered patent drawing section.

“Patent document object” refers to a data structure defined by source code that represents a logical and/or physical object that includes characteristics may include operations/functions/methods that a computer program may perform with respect to the object.

“Part number reference” refers to a text string value comprising one or more words and/or symbols that refer a reader to a part illustrated within a patent drawing of a patent document. In certain embodiments, a part number reference comprises a patent document object that links to, or refers to, a drawing part of a drawing part of a patent document. In certain embodiments, a part number reference comprises one or more terms, including one or more claim terms. A part number reference, in certain embodiments may include a text value used in content of a presentation of the part number reference and/or a markup language element used by computer code to manage the markup language element.

“Document position reference” refers to any word, symbol, phrase, or set of text that refers a reader, user, or logic to another location within the same document. Representative examples of a document position reference include, but are not limited to, “as discussed above . . . ”, “as discussed below . . . ”, “as discussed in the last paragraph . . . ”, “as discussed in the next paragraph . . . ”, and the like. Document position references may be expressed in text, in symbols, in numbers, or a combination of these.

Since a drawing reference 318, part number reference 310, and document position reference 308 comprise a class of document 302 references, i.e., referring a reader to another passage or source, they may be collectively referred to in certain embodiments as cross-references. “Cross-reference” refers to a reference within a text to another part of the text. A cross-reference 320 creates a reference from one part of a document 302 to another part containing related information. A cross-reference 320 comprises one of these references at a given time. A cross-reference 320 may be highly specific, e.g., “see the figure on page 11”, or of a more general nature, e.g, “see above”.

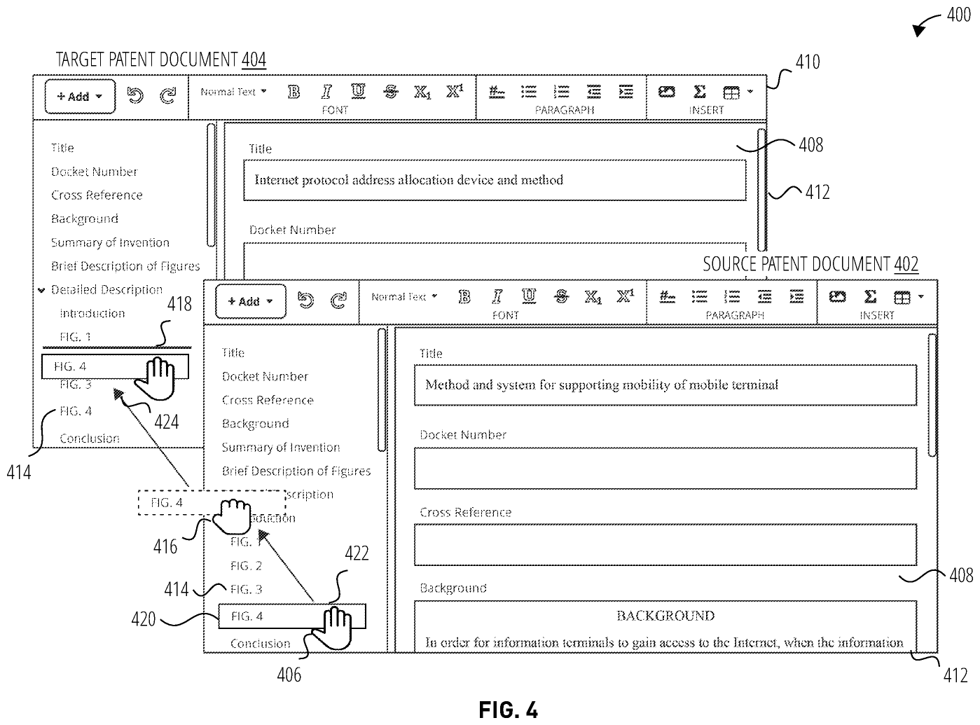

Referring to FIG. 4, two patent documents 400 are illustrated. FIG. 4 illustrates a source patent document 402 and a target patent document 404, and a user interface 408 applicable to both documents. A visual sequence is additionally shown of selecting a section from the source patent document 402 and inserting the section into the target patent document 404. In one embodiment, a user interface 408 comprising both the source patent document 402 and the target patent document 404 is presented to a user 406. The user receives an indication 422 of a patent drawing section 420 in the source patent document 402 for merging that section into the target patent document 404. This indication 422 may comprise a number of user interface cues known to those skilled in the art, e.g. a visual highlight surrounding the information, an icon next to the information, a graphically altered presentation when a user-controlled on-screen cursor moves over information, and so on.

“Patent document” refers to a document created and used in connection with the application process and/or the procurement of a granted patent. Patent document refers to both national patent applications and/or international patent applications and/or both national patent grants and/or international patent grants. References to a “patent document” refer also to an application for protection of an invention. References to an “application” include, but are not limited to, references to applications for patents for inventions, inventors' certificates, utility certificates, utility models, patents or certificates of addition, inventors' certificates of addition and utility certificates of addition.

“Source patent document” refers to a source document that is a patent document.

“Target patent document” refers to a target document that is a patent document.

In another embodiment, the user interface 408 additionally comprises a graphical user interface 410 divided into areas of a screen devoted to various purposes, e.g., presenting icons, text display, user interactions, and so forth. A user interface 408 may be divided into windows, each window 412 displaying to the user 406 a subdivision of the larger user interface 408. With two or more windows displayed, in one embodiment a user 406 may view multiple documents, including patent documents, in separate windows. In one embodiment, a user 406 may view a source patent document 402 and a target patent document 404 in two windows, respectively. The labels “source” and “target” refer to the potential of copying and/or inserting parts of one document into another. An icon 414 may additionally display within each window 412. In one embodiment the icon 414 represents one of a patent drawing section 420 of either the source patent document 402 or the target patent document 404. Icons may be present in both windows of the user interface 408 for the purpose of a user 406 comparing like elements across windows. The graphical user interface 410 in a multiple window 412 environment may accept a user input 416 such that a user 406 visually moves an icon 414 from one window 412 to another by accessing a user input 416 function, e.g., a “grab and drop” function. In this fashion, a user 406 may visually drag an icon 414 representing a patent drawing section 420, e.g., “FIG. 4”, from one window 412 to a second window, see a drop location 418 appear when the icon 414 moves over a suitable area of the second window to be inserted, and “release” the icon 414 representing the patent drawing section 420 at the drop location 418. The user interface 408 may provide various visual indicators as this “drag-and-drop” operations takes place. A cursor under control of the user 406 may change, e.g., from an open hand to a closed fist. The icon 414 being moved may visually track across the user interface 408 to indicate its movement. The drop location 418 may also exhibit a graphic change when the icon 414 moves to a position 424 between other icons to indicate the location in the target patent document 404.

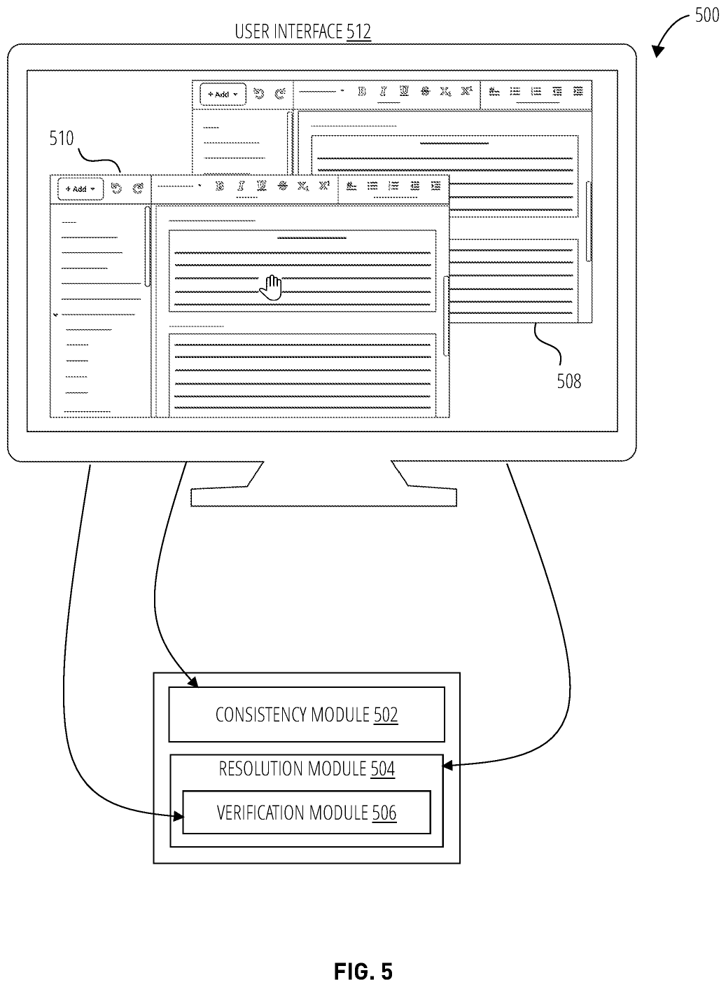

When a patent drawing section 420 is copied or moved from the source patent document 402 to the target patent document 404, any cross-references referring to other patent drawing sections in the source patent document 402 may be identified to be suitably resolved into the target patent document 404. Moreover, when such a resolution takes place, the patent drawing section 420 copied or moved from the source patent document 402, along with another patent drawing section it references, maintains consistency between its cross-references within the target patent document 404. For example, if a user 406 selects the “FIG. 4” icon 414 from the source patent document 402 and inserts it at a drop location 418 into the target patent document 404, the patent drawing section 420 representing “FIG. 4” and all its cross-references are also inserted into the target patent document 404 and the consistency of the cross-references is maintained. FIG. 5 below describes details of these consistency and resolution modules in greater detail.

“Resolution” refers to any steps, processes, actions, or events executed by a software computer program to prevent a cross-reference in a target patent document from being an inconsistent cross-reference, a “broken link.”

Referring to FIG. 5, a user interface and modules 500 is illustrated. As noted above, when moving or copying a patent drawing section from a source patent document 508 to a target patent document 510 by means of a user interface 512 with multiple windows, the consistency of cross-references may be maintained. Additionally, when the patent drawing section merges into the target patent document 510, the patent drawing section and all its cross-references may be resolved.

A consistency module 502 serves to identify cross-references within a patent drawing section of the source patent document 508. In one embodiment, the consistency module 502 identifies another patent drawing section referenced by the patent drawing section. The consistency module 502 may be a software tool able to identify references or links within software object code. For example, a link structure written in HTML or XML source code, e.g., <a href=“location.linkURL”></a>, may include a reference to another object, document, image, and so on. In this example, the link represented by “location.linkURL” may refer to another patent drawing section and the consistency module 502 may identify it by having the computing device 100 search the surrounding text and identifying the start tag (<a>) and end tag (</a>) as a link.

“Object code” refers to the computer code output by a compiler or as an intermediate output of an interpreter. Object code often takes the form of machine language or an intermediate language such as register transfer language (RTL).

A resolution module 504 merges the patent drawing section and its cross-references into the target patent document 510. It additionally performs the task of maintaining consistency between all the cross-references in the target patent document 510, including those introduced by the patent drawing section and its cross-references from the source patent document 508. The resolution module 504 may be a software tool configured by the computing device 100 to search the object code for all the patent drawing sections in the target patent document 510. The computing device 100 may then compare the cross-references of the patent drawing sections to those of the newly merged patent drawing section from the source patent document 508. Consistency between cross-references in the target patent document 510 may be defined according to the user interface 512 presentation. For example, if a cross-reference merged from the source patent document 508 refers to an object within the target patent document 510 with the same name, the merged cross-reference may be appended with the text string “_copy”, e.g., “link_to_FIG.7 copy”. This appendage may both retain the integrity of the original cross-reference in the target patent document 510 and flag a potential “broken link” in the merged cross-reference that needs the attention of the user.

Within the resolution module 504, a verification module 506 notifies the user, via the user interface 512, when one or more cross-references as described above need user attention. The verification module 506 may be a software tool or computer program configured by the computing device 100 to present a display on the user interface 512 when the resolution module 504 encounters a merged cross-reference from the source patent document 508. For example, when the aforementioned search finds conflicting cross-references, the verification module 506 may run a subroutine presenting a choice to the user. Such a choice may display to the user as:

cross-references in the figure (name) conflict with existing references—do you want to:

1) delete the old cross-reference (overwrite)

2) disregard the new cross-reference (keep original)

3) keep both?

In the first two cases the indicated cross-reference may be deleted and the retained one updated as needed. In the last case, the newly merged cross-reference may be re-named, appended, or otherwise flagged in the user interface 512 for the user to attend.

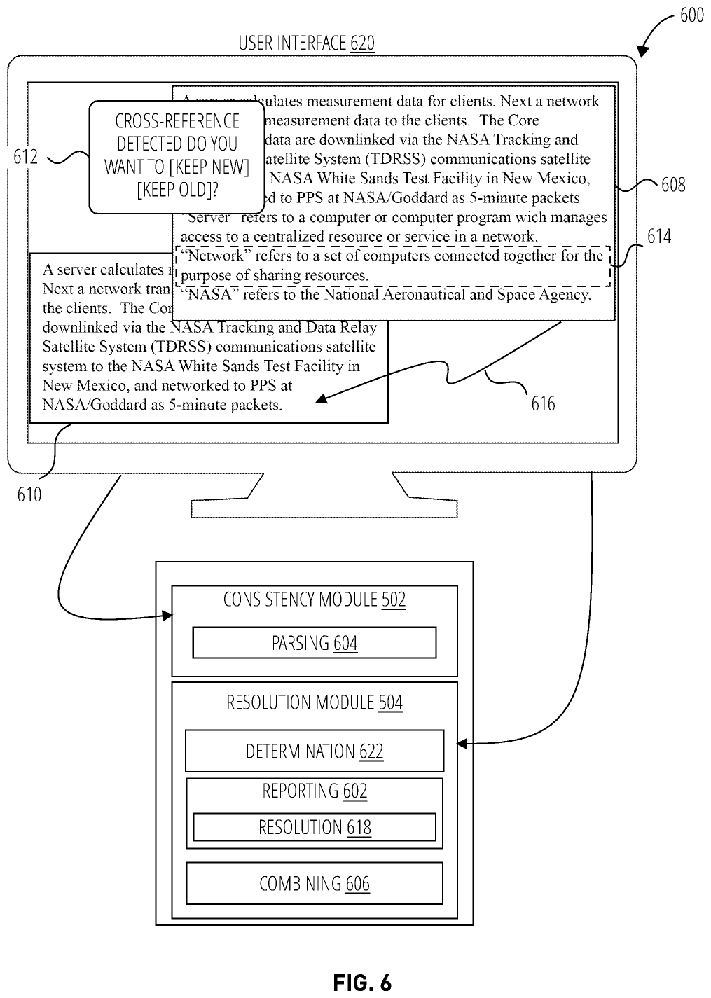

Referring to FIG. 6, a user interface and module detail 600 are illustrated. As with the embodiments discussed above and illustrated in FIG. 5, this figure illustrates detecting and handling cross-references to unselected sections of a document to avoid the neglect of the cross-references, e.g., “broken links”. The documents in this instance may be of any type utilizing cross-references, e.g., contracts, grant proposals, requests for proposals (RFPs) and responses, and so on. Use of a source document 608, target document 610, and maintaining cross-references between the two comprises the features under examination. The source document 608 may take any form from which the cross-referencing techniques described herein apply, e.g., table of contents, glossary, footnotes, and so on. In one embodiment the source document may not contain displayable text, such as a drawing window of a graphic application (e.g., Adobe Illustrator, Visio, etc.).

A selected section 614 of text in a source document 608 may undergo parsing 604 by a software routine within the consistency module as described above. In this case, the selected section 614 of the source document 608 has been highlighted in the user interface 620 by a user for merging into the target document 610. Parsing 604 may identify at least one cross-reference in the selected section 614 in a manner described above as a software routine run by the computing device 100 within the consistency module 502 for identifying references or links within software object code.

Once the cross-reference has been identified by the parsing 604 routine, a determination 622 of a cross-referenced section is performed by the computing device 100. The cross-referenced section 616 to which the cross-reference refers in the source document 608 may be linked by object code. That is, the cross-reference and the cross-referenced section pair are explicitly stored in volatile memory or non-volatile memory by the computing device 100. If this pairing does not exist, the computing device 100 may create the link when the user creates it in the user interface 620. The user may do this by many means known to those skilled in the art. For example, a cross-referenced section may comprise a footnote to a cross-reference and be visually paired in the user interface by a number or symbol.

An attempt to merge the cross-referenced section into the target document triggers a reporting 602 process by the computing device 100. In one embodiment, reporting 602 first comprises generating a notification 612 to the user on the user interface 620 that the selected section comprises at least one cross-reference. The notification 612 comprises a visual query to the user asking to either keep the new cross-reference or retain the original cross-reference. A user may confirm an intention to merge the cross-referenced section 616 into the target document 610 by interactively selecting “Keep New” or a similar choice from the notification 612. Making either choice represents a resolution 618 by the user. In this instance, the selected section 614, including the cross-reference to the cross-referenced section 616, merges into the target document 610. Each cross-referenced section may include at least one numeric reference.

The final step for the resolution module 504 comprises combining 606 the cross-referenced section into the target document 610. Combining 606 may comprise inserting the cross-referenced section at an insertion point or appending it to the end of a section. “Insertion point” refers to a position within a set of: text, documents, or sections, for inserting another set of text, a section, a patent drawing section, a paragraph, a sentence, or the like. Combining 606 may also comprise merging it into the target document 610 based on its textual structure. For example, if the cross-referenced section comprises a sentence with no line breaks it may be inserted as an inline definition. Alternatively, if the cross-referenced section comprises a block-level element, it may be inserted at the end of a sentence or end of a paragraph.

“First occurrence” refers to first instance of a term within a sentence, paragraph, subsection, section, document, or set of documents. “Definition” refers to a statement of the meaning of a word or word group or a sign or symbol, such as a keyword. In certain embodiments, a definition comprises a term, one or more words, phrases, or symbols, and punctuation organized into a sentence. In one embodiment, a definition comprises one or more sentences organized into one or more paragraphs. In certain embodiments, a definition may replace a keyword. In one embodiment, a definition may include the keyword associated with the definition. In one embodiment, a definition comprises an expanded form of an abbreviation, an acronym, or the like.

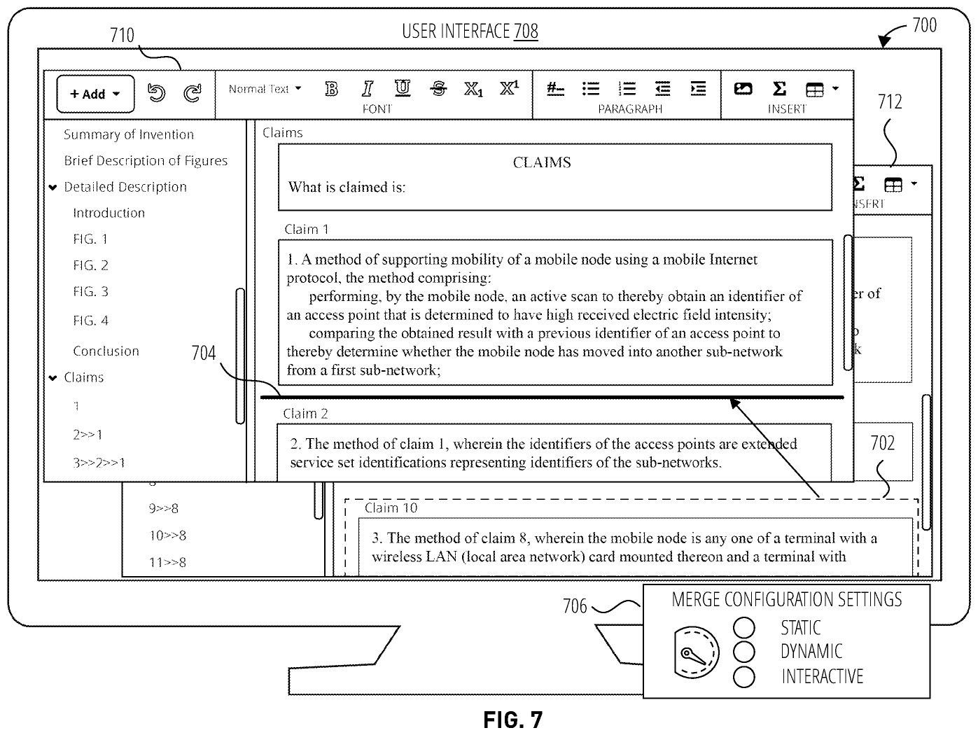

Referring to FIG. 7, merge attributes 700 are illustrated. As shown, two patent documents, a source patent document 712 and target patent document 710, demonstrate inserting a selected section 702 and a cross-referenced section into the latter from the former. The determination of where the selected section 702 merges into a target document, shown here as an exemplary target patent document 710, may be based on settings or attributes for the document. A merge attribute 706 may determine the location of the insertion point 704 for the merged selected section 702 and cross-referenced section. “Merge attribute” refers to any data, data value, setting, configuration, or indicator configured to manage how a merge operation is conducted on a target patent document. In certain embodiments, merge attributes are static settings that are defined when the merge logic is implemented in a software computer program. Merge attributes that are static may be defined when the software computer program is written or may be adjustable based on one or more configuration settings that may be adjustable by a user. In certain embodiments, merge attributes are dynamic settings that are defined when the merge logic is executed on a computing device. For example, when a user implements a user-interface drag and drop operation indicating that one or more figures are to be merged from a source patent document to a particular location within a target patent document, the location indicated as the destination may comprise a merge attribute used to define an insertion point.

The merge attribute 706 additionally may comprise user-selectable characteristics. For example, a merge attribute 706 may be static, e.g., when a selected section 702 and cross-referenced section are merged into a target document no rearrangement of the target document takes place. In this instance the text of the selected section 702 and cross-referenced section simply inserts at an insertion point 704 determined by the user on the user interface 708. This may be at a graphically highlighted area on the graphical user interface beneath a cursor or other interactive indicator under user control. In one embodiment, a merge attribute 706 may be dynamic. Merging a selected section 702 and cross-referenced section into a target document in this instance updates the section(s) at the insertion point 704 along with all cross-references affected by the attributes of the inserted cross-referenced section.

In another embodiment, a merge attribute 706 may display an interactive query on the user interface 708 asking the user to determine how the merging of the selected section 702 and cross-referenced section affects the remainder of the target document. These choices may comprise overwriting previous cross-references, ignoring new cross-references, and so on. In one embodiment, the insertion point 704 determined by a merge attribute 706 may be after the last section of a set of sections. In this instance the selected section 702 and cross-referenced section may append at the end of a section where a user attempts to merge the text without attempting to dynamically or interactively rearrange the text or sections of the target document.

In one embodiment, merge attributes may be determined on a document basis. In this instance, the merge attributes may be represented by object code. This object code may be included with a computer file comprising the document. In another embodiment, the merge attributes may be determined by the computing device 100. In this instance, object code representing the merge attributes may apply to documents processed by the computing device 100.

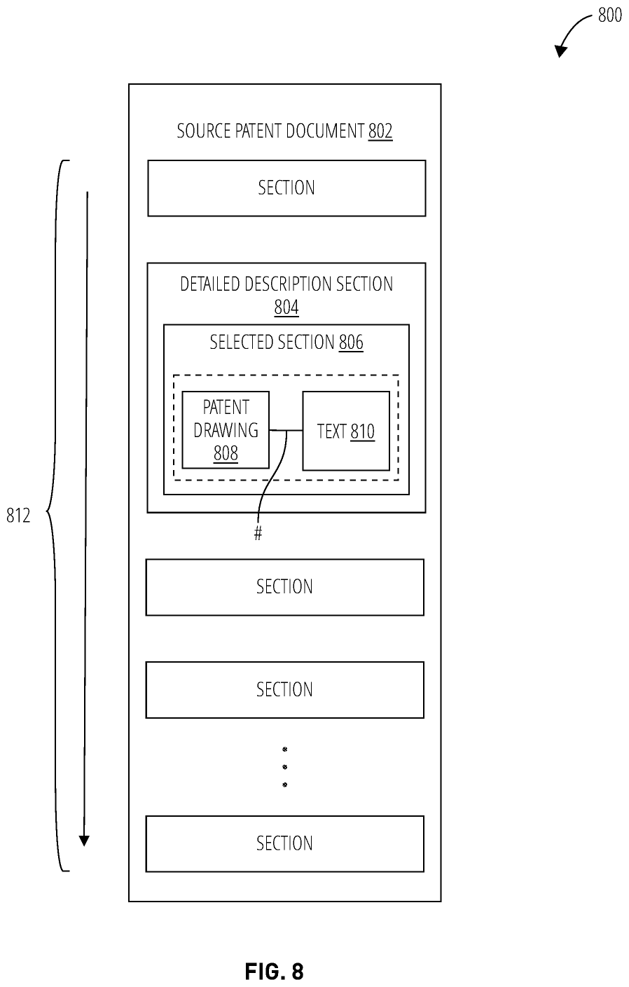

Referring to FIG. 8, a source patent document 800 is shown. In one embodiment, the source document as described above and illustrated in FIG. 6 may comprise a source patent document 802, a document type well known to those skilled in the art. The source patent document 802 additionally comprises a number of ordered sections 812 and figures (drawings). The ordered sections 812 may include a title section, abstract section, introduction section, summary section, short description of figures section, detailed description section, claims section and so forth. “Detailed description section” refers to a section of a patent document that describes how to make and/or use an disclosure recited in a claims section. In certain embodiments, a “detailed description section” may be referred to simply as a “description section”. For example, where the patent document is an international application filed under a Patent Cooperation Treaty, the terms “detailed description section” and “description section” may be synonymous. Consequently, in certain embodiments, “detailed description section” may refer to a section of a mandatory part of the international application which discloses the solution in a manner sufficiently clear and complete for the solution to be carried out by a person skilled in the art.

Turning specifically to the detailed description section 804 of the source patent document 802, this section describes, in numerical order, patent drawings and text 810 associated with each patent drawing 808. A selected section 806, e.g., one that includes a cross-reference as defined above, may comprise in one embodiment both a patent drawing 808 and text 810 associated with the patent drawing 808. An illustrated referring mark (#) here denotes the connection between the drawing and text. In this instance the text 810 may describe the patent drawing 808 in the detailed description section 804 of the source patent document 802. The description comprises all part number references in the patent drawing 808 in addition to any cross-references.

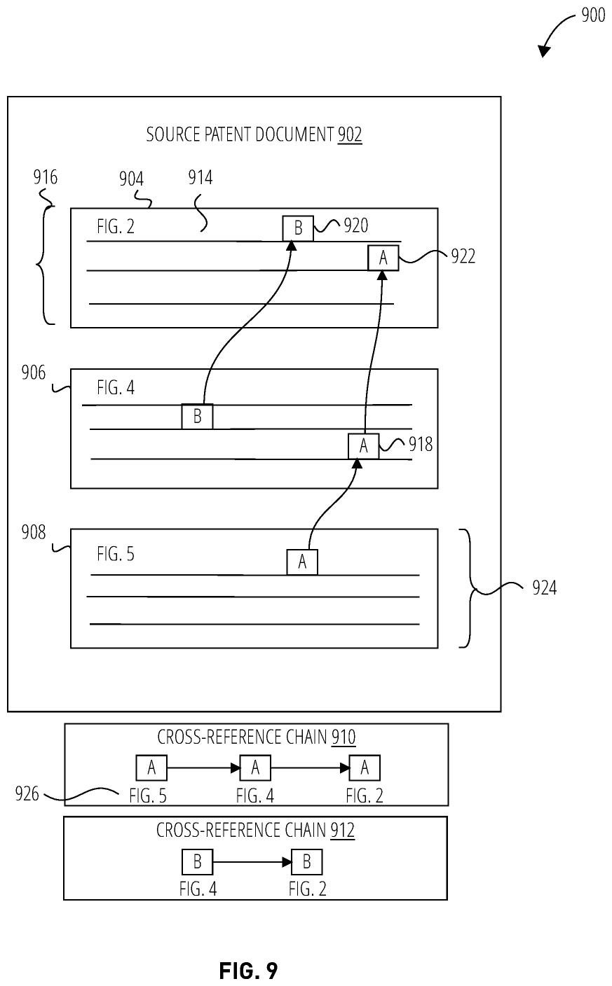

Referring to FIG. 9, source patent document 900 is shown. The source patent document 902 may comprise at least three patent drawing sections for FIG. 2 904, FIG. 4 906, and FIG. 5 908. These sections comprise text 914 as shown schematically in the figure. Cross-references exists across these sections. A cross-reference “A” identified in FIG. 5 908 may lead to FIG. 4 906. Similarly, cross-reference 918 A in FIG. 2 904 may refer to the same cross-reference as that shown in section 916 of FIG. 4 906, which refers to the same one in FIG. 5 908. Likewise, an examination of FIG. 4 906 may identify a second cross-reference “B” leading to FIG. 2 904. Two or more cross-references across multiple sections comprise a cross-reference chain.

Two specific cross-reference chains across the three shown figures are cross-reference chain 910 and cross-reference chain 912. A cross-reference chain may contain multiple cross-references. As the label “chain” implies, a cross-reference chain comprises a beginning and an end. Each of cross-reference chain 910 and cross-reference chain 912 may have a tail section, such as the tail section 922 shown for cross-reference chain 910. The FIG. 4 906 and FIG. 5 908 sections may reference “A” and “B” found in FIG. 2, but FIG. 2 904 may contain no cross-references to other sections.

“Cross-reference chain” refers to a set of cross-references that form a chain of associations, or links, between two or more sections of a document.

“Tail section” refers to a section that is referenced by another section, but itself contains no cross-references to other sections. With no links to other sections, a tail section may be the last link in a cross-reference chain.

The reporting 602 process as described above and illustrated under FIG. 6 may accommodate cross-reference chains. That is, since reporting 602 comprises generating a notification to the user to confirm or abandon a new cross-reference, this notification may additionally comprise having a user confirm or abandon a new cross-reference chain. This notification may appear whenever a cross-reference comprises part of a cross-reference chain.

In one embodiment a selected section 924, such as the exemplary description of FIG. 5 908, traverses a cross-reference chain 910 through two or more cross-referenced sections to a tail section 922. In this instance the selected section 924 and the cross-referenced section have a predefined order 926. That is, the cross-references from the selected section 924 to the cross-referenced section are not rearranged.

In certain embodiments, a merger from the source document to the target document retains the predefined order 926 of the selected section 924 and the cross-referenced section.

Within a cross-reference chain 910 the cross-referenced section of a selected section 924 may be determined. A computing device 100 first scans the entire source document searching for one or more sections referenced by the cross-reference. Once the referenced sections are found, the cross-referenced section comprises the first section 920 of the source document. For example, as shown, cross-reference “B” may be scanned, and its first section 920 may comprise the cross-referenced section. “First section” refers to an initial section presented to a reader among a plurality of sections of a document having ordered sections.

In certain other embodiments, a cross-reference may refer to two different sections. As shown, the cross-reference “A” in FIG. 5 908 references both a corresponding reference in FIG. 2 904 and FIG. 4 906. In this instance, both references may be considered cross-referenced sections.

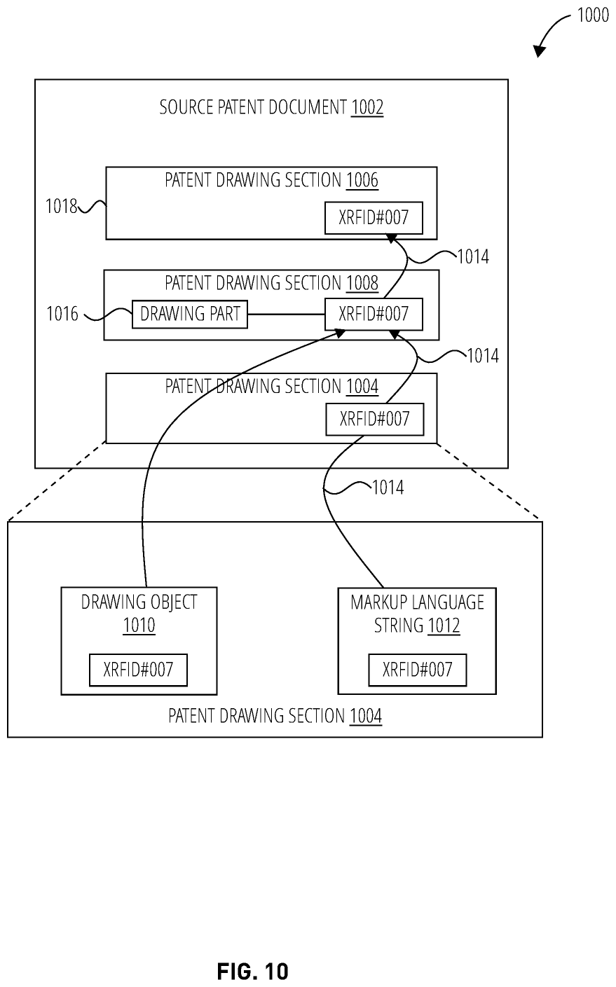

Referring to FIG. 10, a source patent document 1000 is illustrated. Three patent drawing sections are shown within a source patent document 1002: patent drawing section 1006, patent drawing section 1008, and patent drawing section 1004. Each patent drawing section comprises a drawing object 1010 and a markup language string 1012, as shown expanded for patent drawing section 1004. A drawing object 1010 comprises object code that electronically draws objects to a screen when interpreted by a computing device 100. An exemplary drawing object 1010 may be a figure represented within the patent drawing section of a patent document. Computer code with tags comprises markup language strings written in a markup language. Markup language strings typically include tags at the beginning and end of each string, referred to as a start tag and an end tag, respectively. Exemplary markup languages include HTML and XML, are often used for interpreting markup language strings for processing and/or display by a web browser. Exemplary tags at each end of a markup language string may be processed by a computing device 100 to refer to other sections of a document. That is, each cross-reference may comprise tags in a markup language string and may include a part number reference, such as “XRFID #007”, which may be also appear in other sections, and may thus be referenced as shown by reference 1014.

Each patent drawing section comprises text composed of markup language strings. As markup languages include tags referring to other document sections, a markup language string 1012 may contain cross-references to references in the same or other documents. As shown, a computing device 100 may determine that a markup language string 1012 and drawing object 1010 in patent drawing section 1004 may contain a first cross-reference to a second patent drawing section 1008. The computing device 100 may then determine that the second patent drawing section 1008 includes the same first cross-reference to a third patent drawing section 1006. As noted above, these three cross-references across three patent drawing sections comprise a cross-reference chain.

The consistency module as described above and illustrated in FIG. 5 is configured by the computing device 100 to search for a tag for each cross-reference. In certain embodiments, the consistency module may search within one or more of the drawing object and the markup language string, as illustrated in patent drawing section 1004. The cross-reference search data in certain embodiments may comprise a part number reference, shown here as “XRFID #007”. This part number reference may, in one embodiment, additionally refer to a drawing part 1016 introduced in the second patent drawing section 1008. The consistency module continues searching for tags for each cross-reference until the last section 1018, shown schematically here as patent drawing section 1006, is searched.

Once cross-references through all patent drawing sections have been found by the computing device 100, the sections are copied to computer memory. In certain embodiments, these cross-referenced sections, comprising the first patent drawing section 1004, second patent drawing section 1008 and third patent drawing section 1006, append onto the end of a target patent document. That is, the computing device 100 first searches for the end of the target document, e.g., by finding the last character in the target document file. The computing device 100 then copies the patent drawing sections from memory at the end of the target document.

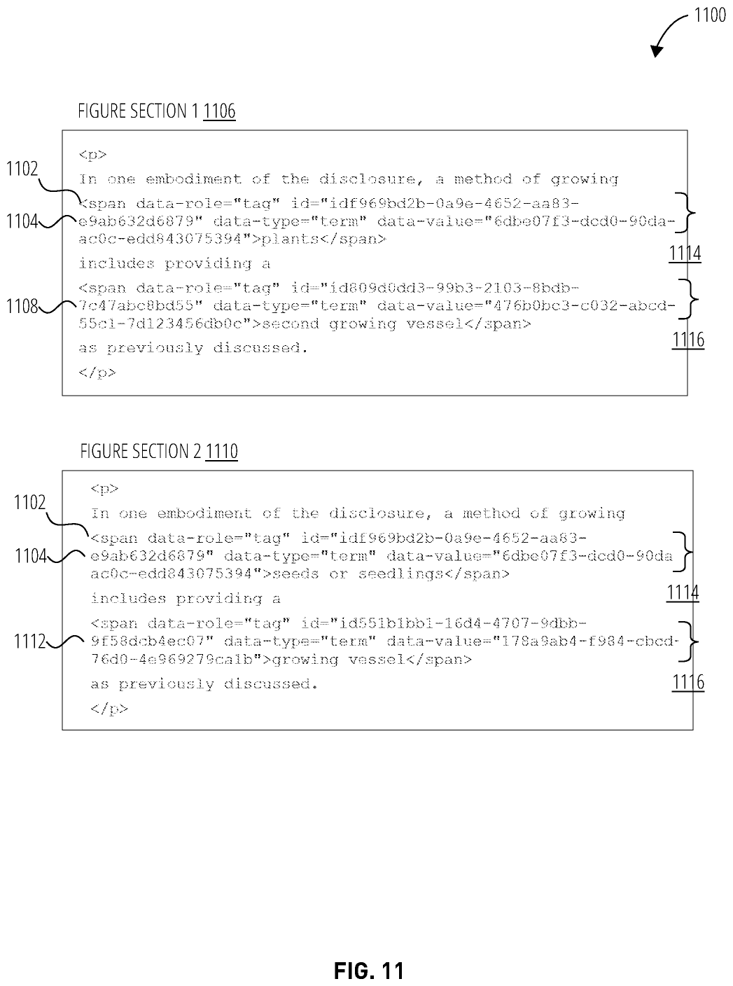

Referring to FIG. 11, figure sections 1100 are illustrated. A part of two sections of a patent document are shown, figure section 1 1106 and figure section 2 1110. These sections represent patent drawing sections describing figures in the patent. As described above and illustrated under FIG. 10, a patent drawing section may comprise a drawing object and a markup language string. This illustration provides additional details of how the drawing object and markup language string are represented in markup language.

As shown, each patent drawing section contains two markup language elements, one for a cross-reference 1114 and one for a drawing object 1116. The markup language element for the cross-reference 1114 may be a markup language string. The cross-reference 1114 comprises a first markup language element 1104, as shown within the <span> tag, that comprises a reference to a second markup language element. The markup language element 1104 is illustrated by the parameters within the <span> tag. As known to those skilled in the art, the “data-role”, “id”, “data-type” and “data-value” parameters comprise the values to provide a link to the second markup language element. Note in this instance the markup language element 1104 for each cross-reference 1114 have the same parameters, which may comprise a global unique identifier (UUID). With the same UUID, representing the same markup language element 1104, the cross-references link to the same reference. Note the markup language element 1108 for the drawing object 1116 in the figure section 1 1106 may differ from the markup language element 1112 for the drawing object 1116 of figure section 2 1110. These differing markup language elements may thereby have differing UUIDs and link to differing references.

Each cross-reference 1114 additionally comprises a markup language tag 1102. The tag 1102 is a <span> tag, known to those skilled in the art as comprising parameters and identifiers to provide a reference to another section of a document. As noted above, the parameters within the <span> tag comprise references to other patent drawing sections. References are shown as the specific values equated to the <span> tag parameters.

The consistency module, as described and illustrated above under FIG. 5, searches for the tag for each cross-reference in the patent drawing section. Since the patent drawing section comprises the markup language string and drawing object 1116, the consistency module searches for the tag representing each cross-reference. In this instance, the tag may be the <span> tag comprising the markup language element. The parameters within the <span> tag may be processed by the computing device 100 to determine the reference to another markup language element and thereby another cross-reference.

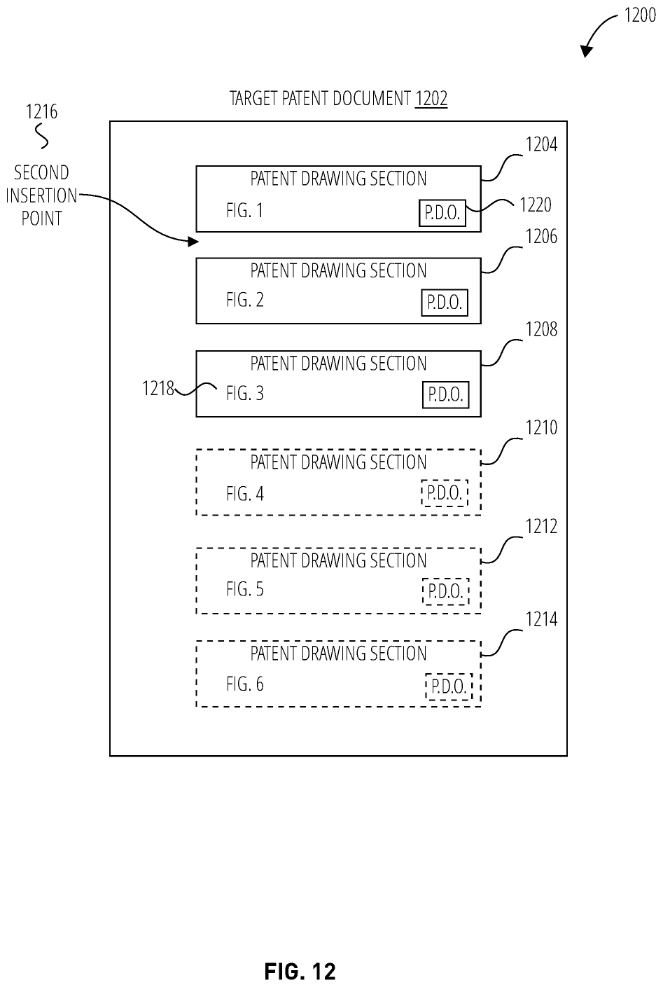

Referring to FIG. 12, target patent document 1200 is illustrated. When a selected section and cross-referenced section merge into a target document, such as a target patent document 1202 as previously described, one of a plurality of rearrangements may take place. In one embodiment, when a selected section inserts at the second insertion point 1216 as shown, the other sections within the target patent document 1202 automatically re-order based on this insertion while a predefined order between the selected section and a cross-referenced section is maintained. In this instance, a patent drawing section inserted at the second insertion point 1216, e.g., between patent drawing section 1204 and patent drawing section 1206 maintains the predefined order between the selected section and cross-referenced section being inserted while reordering the subsequent sections. In another embodiment, the insertion point may be after a last section, e.g., after patent drawing section 1214, within a set of sections such as patent drawing section 1204 to patent drawing section 1214.

In another embodiment, merging the cross-referenced section into the target document, such as the target patent document 1202 as shown, renumbers each cross-reference and each numeric reference 1218 both within the selected section (e.g., in this case, the detailed description section of a patent document) and the cross-referenced sections such that compatibility of each cross-reference and numeric reference 1218 maintains throughout the target document. For example, a merger at the second insertion point 1216 causes renumbering such that FIG. 2 becomes FIG. 3, FIG. 3 becomes FIG. 4, and so on, within the target patent document 1202 while each cross-reference is renumbered as well.

Whether merging a cross-reference and/or cross-referenced section into the target patent document 1202 has caused a reordering, appending, or renumbering of sections, the resolution module, as described above and illustrated in FIG. 5, resolves changes to the target patent document 1202 by preforming a similar reordering, appending, or renumbering of each patent document object 1220 of the affected sections. The resolution module, in one embodiment, may be a software tool configured to search and, where instructed, replace or edit the object code of the patent document objects for all sections in the target patent document 510, comparing the cross-references of the sections to those of the newly merged section(s) from the source patent document. Based on the comparison and the new reordering, appending, or renumbering of sections, the resolution module modifies the patent document objects accordingly to maintain links to other patent document objects in the target patent document 1202. For example, if a new section inserts between patent drawing section 1208 and patent drawing section 1210 in FIG. 12, the resolution module may modify the patent document objects for patent drawing section 1210, patent drawing section 1212, and patent drawing section 1214 to both update the figure numbers for those sections (e.g., from 4, 5, 6, to 5, 6, 7) and modify the object code for all other cross-references in the target patent document 1202 referencing those section figure numbers.

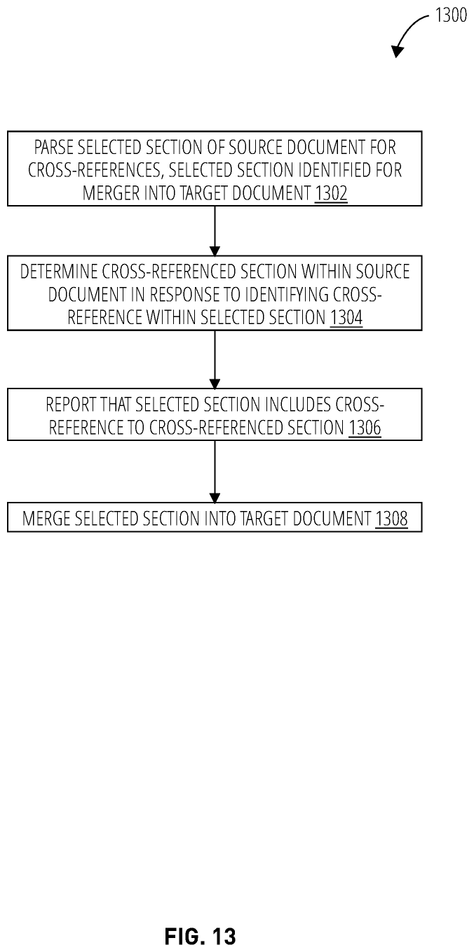

Referring to FIG. 13, in block 1302, routine 1300 parses a selected section of a source document for cross-references, the selected section identified for merger into a target document. In block 1304, routine 1300 determines a cross-referenced section within the source document in response to identifying a cross-reference within the selected section. In block 1306, routine 1300 reports that the selected section includes a cross-reference to the cross-referenced section. In block 1308, routine 1300 merges the selected section into the target document.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

Herein, references to “one embodiment” or “an embodiment” do not necessarily refer to the same embodiment, although they may. Unless the context clearly indicates otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

1. A method comprising:
parsing a selected section of a source document for at least one cross-reference, wherein the selected section is identified for insertion into a target document and wherein the source document and the target document are treated as unrelated and independent sets of document content;
determining at least one cross-referenced section within the source document in response to identifying the at least one cross-reference within the selected section;
reporting that the selected section includes the at least one cross-reference to the at least one cross-referenced section;
determining an insertion point for the selected section and the at least one cross-referenced section based on at least static merge attributes for the target document, wherein the static merge attributes are independent of content and attributes for the source document; and
merging the selected section into the target document at the insertion point.

2. The method of claim 1, wherein:
reporting comprises generating a notification that the selected section comprises the at least one cross-reference; and
merging comprises merging the at least one cross-referenced section into the target document in response to confirming that a user intends for the at least one cross-referenced section to merge into the target document.

3. The method of claim 1, wherein the at least one cross-referenced section comprises a secondary cross-reference, the method further comprising traversing a cross-reference chain from the selected section through two or more cross-referenced sections to a tail section, and wherein reporting further comprises reporting that the selected section is part of the cross-reference chain that includes the two or more cross-referenced sections.

4. The method of claim 1, wherein the at least one cross-referenced section and selected section have a predefined order within the source document and merging comprises:
inserting the at least one cross-referenced section and selected section into the target document with the at least one cross-referenced section and selected section maintaining the predefined order.

5. The method of claim 4, further comprising:
reordering sections within the target document and maintaining the predefined order between the at least one cross-referenced section and selected section.

6. (canceled)

7. The method of claim 4, wherein the insertion point comprises a position after a last section within a set of ordered sections.

8. The method of claim 1, further comprising:
parsing the selected section through operation of a consistency module configured by a computing device to recognize the at least one cross-reference within software object code, wherein the at least one cross-reference comprises a first markup language element comprising a reference to a second markup language element;
determining the at least one cross-referenced section within the source document in response to identifying the at least one cross-reference within the selected section through operation of the consistency module wherein the at least one cross-referenced section corresponds to the second markup language element;
reporting that the selected section includes the first markup language element referencing the second markup language element through operation of a resolution module configured by the computing device to merge the selected section and the at least one cross-referenced section into a target patent document and maintain consistency between cross-references within the target patent document.

9. The method of claim 1, wherein the cross-reference comprises one of a drawing reference, a part number reference, and a document position reference.

10. The method of claim 1, wherein the source document comprises a source patent document and the selected section comprises a patent drawing and text associated with the patent drawing within a detailed description section of the source patent document.

11. The method of claim 1, wherein merging comprises:
merging the at least one cross-referenced section into the target document, wherein each cross-referenced section includes at least one numeric reference; and
renumbering each cross-reference and each numeric reference within the selected section and within the at least one cross-referenced section such that each cross-reference and each numeric reference maintain compatibility within the target document.

12. The method of claim 1, wherein determining the at least one cross-referenced section comprises:
scanning the source document for one or more sections referenced by the cross-reference in the selected section; and
designating the one or more sections referenced by the cross-reference in the selected section as cross-referenced sections.

13. A system comprising:
a user interface configured to present a source patent document and a target patent document to a user and receive an indication from the user of a patent drawing section of the source patent document for merger into the target patent document, wherein the source patent document and the target patent document are treated as unrelated and independent sets of document content;
a consistency module configured to identify a cross-reference within the indicated patent drawing section, the cross-reference referencing another patent drawing section of the source patent document; and
a resolution module configured to merge the indicated patent drawing section and the another patent drawing section into the target patent document at an insertion point based on at least static merge attributes for the target document, wherein the static merge attributes are independent of content and attributes for the source document, and maintain consistency between cross-references within the target patent document.

14. The system of claim 13, wherein the user interface comprises a graphical user interface comprising a first window configured to display icons representing patent drawing sections of the source patent document and a second window configured to display icons representing patent drawing sections of the target patent document, wherein the graphical user interface is configured to accept user input that visually drags an icon displayed in the first window, to a drop location displayed in the second window, the drop location comprising a position relative to the icons representing the patent drawing sections of the target patent document.

15. The system of claim 13, wherein:
each patent drawing section comprises a drawing object and a markup language string;
each cross-reference comprises a tag comprising a reference to the another patent drawing section; and
wherein the consistency module is configured to search for a tag for each cross-reference within one or more of the drawing object and the markup language string.

16. The system of claim 13, wherein the resolution module is further configured to modify one or more patent document objects within the target patent document such that the patent document objects comprise consistent links to other patent document objects within the target patent document.

17. The system of claim 13, wherein the resolution module comprises a verification module configured to notify a user of one or more cross-references in the indicated patent drawing section and determine a resolution based on user input.

18. A computing apparatus comprising:
a processor; and
a memory storing instructions that, when executed by the processor, configure the apparatus to:
determine a first patent drawing section identified for insertion into a target patent document, wherein a source document for the first patent drawing section and the target patent document are treated as unrelated and independent sets of document content;
determining that the first patent drawing section comprises a first cross-reference to a second patent drawing section;
determining that the second patent drawing section comprises the first cross-reference to a third patent drawing section; and
appending the first patent drawing section, the second patent drawing section, and the third patent drawing section onto the target patent document at an insertion point based on static merge attributes for the target document, wherein the static merge attributes for the target document are independent of content and attributes for the first patent drawing section, the second patent drawing section, and the third patent drawing section.

19. The apparatus of claim 18, wherein the first cross-reference references the second patent drawing section and the first cross-reference of the second patent drawing section references the third patent drawing section.

20. The apparatus of claim 18, wherein the first cross-reference comprises a part number reference that refers to a drawing part introduced in the second patent drawing section.

21. The method of claim 1, wherein the insertion point is determined based on a combination of the static merge attributes for the target document and dynamic merge attributes defined when the selected section is merged.
